(19) United States
(12) Patent Application Publication
(10) Pub. No.: US 2012/0080061 A1
(43) Pub. Date: Apr. 5, 2012

(54) Apparatus For Drying Substrate

(75) Inventors: Young-Hoo Kim, Hwaseong-si (KR); Kun-Tack Lee, Suwon-si (KR); Seung-Yul Park, Hwaseong-si (KR); Yong-Bum Kwon, Yongin-si (KR)

(73) Assignee: Samsung Electronics Co., Ltd., Suwon-si (KR)

(21) Appl. No.: 13/242,442

(22) Filed: Sep. 23, 2011

(30) Foreign Application Priority Data
Oct. 4, 2010 (KR) 10-2010-0096349

(51) Int. Cl. B08B 3/10; B08B 11/00; F26B 7/00; B08B 3/02

(52) U.S. Cl. 134/95.2; 34/427

(57) ABSTRACT

Example embodiments relate to an apparatus for drying a substrate. The apparatus may include a housing including first barrier walls having a first height, a rotary chuck that is disposed within the housing and configured to rotate the substrate, a nozzle system that is disposed above the rotary chuck and configured to supply a fluid onto the substrate, a cleaning liquid supply unit supplying a cleaning liquid for cleaning the substrate to the nozzle system, and a drying liquid supply unit supplying a drying liquid for drying the substrate to the nozzle system.

### CROSS-REFERENCE TO RELATED APPLICATION

This application claims priority under 35 U.S.C. §119 to Korean Patent Application No. 10-2010-0096349, filed on Oct. 4, 2010 in the Korean Intellectual Property Office, the contents of which are herein incorporated by reference in its entirety.

### BACKGROUND

1. Field

Example embodiments of the present invention relate to an apparatus for drying a substrate, and more particularly, to an apparatus for cleaning and drying a substrate having a pattern thereon.

2. Description of the Related Art

Manufacturing semiconductor devices generally involves repeatedly performing individual processes such as a deposition process, a photolithography process, a chemical mechanical polishing (CMP) process, a cleaning process, and a drying process. In particular, the cleaning process is used to remove foreign materials remaining on a surface of a semiconductor substrate, or undesired films formed on the substrate during each individual process. As the size of patterns formed on a semiconductor substrate decreases and the aspect ratio of the pattern increases, the cleaning process becomes increasingly important.

An apparatus for cleaning and drying a substrate is classified into a batch type substrate drying apparatus and a single type substrate drying apparatus.

In a batch type substrate drying apparatus, after immersing a wafer holder containing a plurality of wafers in a cleaning solution such as deionized (DI) water, isopropyl alcohol (IPA) is supplied over the cleaning solution and creates an interface on the DI water. The cleaning solution and the IPA may be drained out from the wafer, or the wafer holder is raised so that a surface of the wafer can be dried. The batch-type substrate drying apparatus is able to process a batch of wafers at one time. However, it is relatively difficult to remove deionized water between relatively fine patterns formed on a wafer surface as the size of patterns on a wafer surface decreases, thereby degrading the drying efficiency. Thus, to efficiently dry relatively fine patterns on a wafer surface, a single-type substrate drying apparatus has been proposed.

A single-type substrate drying apparatus is configured to sequentially clean each wafer during cleaning/drying operations. The single-type substrate drying apparatus generally cleans a wafer by rotating a wafer held on a spin chuck at constant speed and spraying various kinds of solutions or gas onto a rotating wafer. The single-type substrate drying apparatus may be more effective in removing a cleaning liquid remaining between relatively fine patterns and drying a wafer than a batch-type substrate drying apparatus. For example, a relatively fine pattern with a relatively high aspect ratio, and in particular, a pattern having a height that is greater than its width (e.g., micro-capacitors in a dynamic random-access memory (DRAM)), may suffer pattern leaning that occurs when a distance between adjacent patterns is reduced due to DI water remaining between patterns during a drying process. This may increase the failure rate of a semiconductor substrate. In further detail, a relatively high surface tension of the residual DI water may be transmitted between patterns and may collapse the patterns. A finer pattern with a relatively high aspect ratio is more susceptible to pattern collapse or deformation since it is affected to a larger degree by surface tension.

### SUMMARY

Example embodiments of the present invention relate to an apparatus for drying a substrate, wherein the apparatus is capable of reducing a surface tension that is transmitted to patterns on the substrate so as to reduce the occurrence of defects in the substrate.

According to example embodiments of the present invention, an apparatus for drying a substrate may include a housing including first barrier walls having a first height, a rotary chuck that is disposed within the housing and rotates the substrate, a nozzle system that is disposed above the rotary chuck and supplies a fluid onto the substrate, a cleaning liquid supply unit supplying a cleaning liquid for cleaning the substrate to the nozzle system, and a drying liquid supply unit supplying a drying liquid for drying the substrate to the nozzle system.

An apparatus for drying a substrate may also include a housing including a first barrier wall having a first height, a rotary chuck that is disposed within the housing so as to rotate the substrate and supports the substrate so that a pattern formed on the substrate faces downward and a rear surface faces upward, a nozzle system that is disposed below the rotary chuck and supplies a fluid onto the substrate, a cleaning liquid supply unit supplying a cleaning liquid for cleaning the substrate to the nozzle system, and a drying liquid supply unit supplying a drying liquid for drying the substrate to the nozzle system.

An apparatus for drying a substrate may further include a rotary chuck disposed within a housing structure, the rotary chuck configured to rotate a substrate; a nozzle system configured to dispense a cleaning liquid from a cleaning liquid supply unit and a drying liquid from a drying liquid supply unit onto the substrate, the drying liquid having a lower surface tension than the cleaning liquid; and a heating system disposed upstream from the nozzle system, the heating system configured to heat at least one the cleaning liquid and the drying liquid.

A method of drying a substrate may include supplying a heated drying solution onto a front surface of the substrate to displace a cleaning solution on the front surface while rotating the substrate at a first speed, the drying solution having a surface tension that is lower than a surface tension of the cleaning solution; increasing a temperature of the substrate by heating a rear surface of the substrate to reduce the surface tension of the cleaning solution so as to facilitate the displacement of the cleaning solution by the drying solution, the rear surface being opposite to the front surface; and expelling the drying solution from the substrate while rotating the substrate at a second speed, the second speed being greater than the first speed.

### BRIEF DESCRIPTION OF THE DRAWINGS

The above and other features and advantages of example embodiments of the present invention will become more apparent when the following detailed description is taken in conjunction with the attached drawings in which:

FIG. 1 illustrates an apparatus for drying a substrate according to example embodiments of the present invention;

FIG. 2 is a graph of a surface tension with respect to a temperature;

FIGS. 3 through 5 illustrate an exhaust system and an isopropyl alcohol (IPA) recycling system in the apparatus of FIG. 1 according to example embodiments of the present invention;

FIGS. 6 through 8 illustrate the configuration of a cleaning liquid supply unit and a drying liquid supply unit in the apparatus of FIG. 1 according to example embodiments of the present invention;

FIG. 9 illustrates the configuration of a nozzle system in the apparatus of FIG. 1

FIG. 10 illustrates another apparatus for drying a substrate according to example embodiments of the present invention;

FIG. 11 is a flowchart of a method for drying a substrate according to example embodiments of the present invention; and

FIG. 12 is a schematic diagram of a method for drying a substrate according to example embodiments of the present invention.

### DETAILED DESCRIPTION

Example embodiments of the present invention will now be described more fully hereinafter with reference to the accompanying drawings. This invention may, however, be embodied in different forms and should not be construed as limited to the examples set forth herein. Rather, the examples herein have merely been provided to ensure that the disclosure will be thorough and complete so that it will fully convey the scope of the invention to those skilled in the art. The same reference numbers indicate the same components throughout the specification. In the attached figures, the thickness of layers and regions may have been exaggerated for clarity.

It will also be understood that when a layer is referred to as being “on” another layer or substrate, it can be directly on the other layer or substrate, or intervening layers may also be present. In contrast, when an element is referred to as being “directly on” another element, there are no intervening elements present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

“The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this invention belongs. It is noted that the use of any and all examples provided herein is intended merely to better illuminate the invention and is not a limitation on the scope of the invention unless otherwise specified. Further, unless defined otherwise, all terms defined in generally used dictionaries may not be overly interpreted.

The present invention will be described with reference to perspective views, cross-sectional views, and/or plan views, in which example embodiments are shown. Thus, it should be understood that the profile of a particular view may be modified according to manufacturing techniques and/or allowances. That is, example embodiments herein are not intended to limit the scope of the present invention but are to cover all changes, variations, and modifications that may be associated with a manufacturing process. Thus, regions shown in the drawings are illustrated in schematic form and the shapes of the regions are presented simply by way of illustration and not as a limitation.

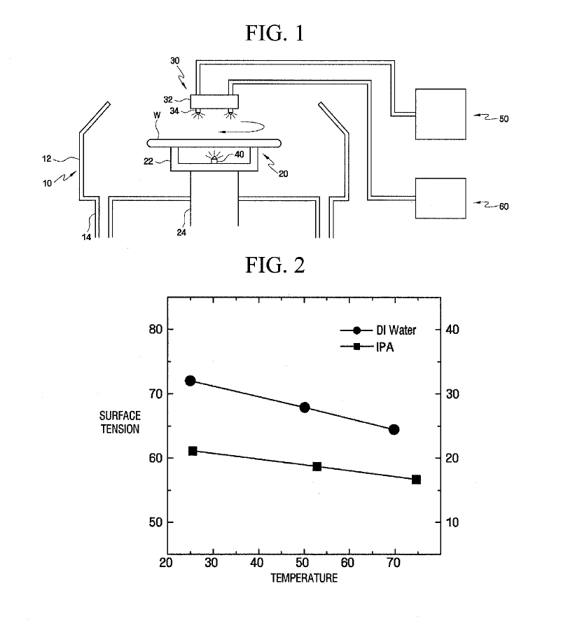

Hereinafter, an apparatus for drying a substrate according to example embodiments of the present invention will now be described in further detail with reference to FIGS. 1 through 9.

Referring to FIG. 1, the apparatus for drying a substrate according to example embodiments may include a housing 10 with first barrier walls 12 having a first height, a rotary chuck 20 disposed within the housing 10 so as to rotate a substrate W, a nozzle system 30 disposed above the rotary chuck 20 so as to supply a fluid onto the substrate W, a cleaning liquid supply unit 50 supplying a cleaning liquid for cleaning the substrate W to the nozzle system 30, and/or a drying liquid supply unit 60 supplying a drying liquid for drying the substrate W to the nozzle system 30.

The housing 10 provides an interior space for cleaning and drying a semiconductor substrate W and may have an open top through which the substrate W is introduced into or withdrawn from the interior space during a drying process. Alternatively, the top of the housing 10 may have a door (not shown) that is closed so as to isolate the interior space from the outside during the cleaning/drying operations. The first barrier wall 12 of the housing 10 surrounding the interior space has the first height. The first barrier walls 12 prevent a cleaning liquid or drying liquid from leaking out of the housing 10 due to a centrifugal force on the rotating substrate W. A top end of the first barrier 12 may be bent inward by a desired angle as shown in FIG. 1. The housing 10 also has a first exhaust port 14 in its bottom surface, through which a cleaning liquid containing contaminants and/or excess drying liquid may be pumped out of the housing 10. As will be described below, the first exhaust port 14 may be connected to a recycling unit 70 so as to recycle the drying liquid (particularly when the drying liquid is more expensive than the cleaning liquid).

The rotary chuck 20 is disposed within the housing 10 and chucks and rotates the substrate W at a constant speed. A spin chuck may be used as the rotary chuck 20. The rotary chuck 20 includes a spin head 22 rotatably installed to rotate the substrate W, a rotary shaft 24 defining the central axis of rotation, and a drive device (not shown) for rotating the rotary shaft 24. The spin head 22 is approximately cylindrical. The spin head 22 has a top surface on which the substrate W is supported during the cleaning/drying process. The rotary shaft 24 has one end connected to a bottom center of the spin head 22 and the other end connected to the drive device. The substrate W may be fixedly mounted on the spin head 22 and may have a front surface with a pattern thereon facing up and a rear surface facing down. The rotary chuck 20 including the drive device may be installed to be able to move vertically so as to adjust the height of the substrate W.

A cleaning liquid such as deionized (DI) water may be used to clean the substrate W (which may have a relatively fine pattern thereon). The DI water may be removed from the substrate W by replacing it with a drying liquid. Since the DI water has a higher surface tension than isopropyl alcohol (IPA), the cleaning liquid may be removed using the Marangoni effect as a result of a difference in the surface tension. If a residual cleaning liquid remains in a space between adjacent patterns, fine patterns (particularly relatively fine patterns having a relatively high aspect ratio) cannot be maintained at a constant distance due to a surface tension of the cleaning liquid, thereby causing the patterns to lean. In order to suppress pattern leaning, a surface tension applied to the relatively fine pattern needs to be reduced. That is, to solve the pattern leaning problem, the amount of the cleaning liquid used or the surface tension of the cleaning liquid may be reduced. Alternatively, the surface tension of the cleaning liquid may be lowered while simultaneously reducing the amount of the cleaning liquid used.

As shown in FIG. 2, the surface tension of a liquid decreases as the temperature increases. Thus, since the surface tension of a cleaning liquid decreases when the temperature of the cleaning liquid increases, a surface tension transmitted to a relatively fine pattern from the cleaning liquid may also become lower, thereby suppressing a collapse of the relatively fine pattern. Furthermore, when the temperature of the cleaning liquid increases, molecules in the cleaning liquid diffuse relatively quickly due to the increased kinetic energy. Thus, a residual cleaning liquid remaining between the relatively fine patterns can be replaced with relative ease with a drying liquid. In addition, by increasing the temperature of the drying liquid sprayed onto the substrate W so as to remove the residual cleaning liquid, the Marangoni effect may be increased due to the reduced surface tension of the drying liquid, thereby allowing the residual cleaning liquid to be removed relatively efficiently. That is, the amount of cleaning liquid residing in the relatively fine pattern can be reduced. Thus, the sum of the surface tensions may be decreased to an extent corresponding to the amount that the cleaning liquid is reduced, and a surface tension transmitted to the relatively fine pattern may also be decreased. Accordingly, the collapse of a fine pattern (especially a relatively fine pattern having a relatively high aspect ratio) can be suppressed.

Returning back to FIG. 1, during the cleaning/drying operations, the nozzle system 30 supplies a cleaning liquid for cleaning the substrate W and a drying liquid for drying the substrate W. The nozzle system 30 includes a nozzle body 32 and a plurality of spray nozzles 34. The nozzle body 32 receives a liquid from the cleaning liquid supply unit 50 or the drying liquid supply unit 60 and transports the liquid to each of the plurality of spray nozzles 34. During a cleaning process, a cleaning liquid is sprayed through the plurality of spray nozzles 34 to clean the substrate W. Following the cleaning process, a drying liquid may be sprayed through the plurality of spray nozzles 34 to remove a residual cleaning liquid remaining on the substrate W. In particular, as described above, when a relatively high-temperature cleaning liquid or drying liquid (greater than 50° C.) is sprayed from the nozzle system 30, the cleaning liquid can be removed from the substrate W with relative ease, thereby preventing the occurrence of water spots since the relatively high-temperature cleaning liquid or drying liquid has a lower surface tension than a cleaning liquid and a drying liquid at room temperature. Furthermore, since a surface tension transferred from a residual cleaning liquid to a pattern is reduced, it is possible to prevent the leaning, collapse, and/or bending of a relatively fine pattern having a relatively high aspect ratio which may otherwise cause a failure in the substrate W. Although FIG. 1 shows one nozzle system 30 including two spray nozzles 34, one of which is connected to the cleaning liquid supply unit 50 while the other is connected to the drying liquid supply unit 60, it should be understood that example embodiments are not limited thereto. That is, since the cleaning liquid and the drying liquid may be sprayed at different times, all of the plurality of spray nozzles 34 may be connected to the cleaning liquid supply unit 50 and the drying liquid supply unit 60 so as to spray the cleaning liquid or drying liquid. A nozzle driver (not shown) may allow the nozzle system 30 to move vertically, thereby adjusting a distance between the nozzle system 30 and the substrate W. The nozzle driver may also allow the nozzle system 30 to move horizontally, thereby adjusting the position of the spray nozzles 34 on the substrate W. Alternatively, the nozzle system 30 may include at least two spray nozzles 34, one of which is disposed to spray the liquid onto a center of the substrate W while the other ones are located to spray the liquid onto edges of the substrate W. More specifically, when a relatively high-temperature liquid is sprayed, a cleaning or drying effect may not occur uniformly across the substrate W due to a difference in temperature between a portion of the substrate W onto which the liquid is directly sprayed and a portion of the substrate W onto which the liquid is not sprayed. As a result, some of the patterns may collapse at a relatively low temperature portion of the substrate W due to the increased surface tension. Thus, in order to minimize the temperature difference and suppress the collapse of patterns, the nozzle system 30 may be adapted to include a spray nozzle 34 for spraying the liquid onto the center of the rotating substrate W and another spray nozzle 34 for spraying the liquid onto the edges of the substrate W, so that the liquid is sprayed relatively uniformly over the substrate W.

The apparatus for drying the substrate W may further include a substrate heater 40 disposed on one side of the rotary chuck 20 or at a desired position so as to adjust the temperature of the substrate W. When the substrate W is heated, the temperature of the cleaning liquid remaining on the substrate W increases also. Thus, the surface tension of the cleaning liquid (e.g., DI water) may be reduced such that the cleaning liquid may be replaced with relative ease with the drying liquid when the drying liquid is sprayed, thereby facilitating the removal of the cleaning liquid from the substrate W. The substrate heater 40 may be formed into a nozzle shape and may receive a heated liquid from the cleaning liquid supply unit 50 or the drying liquid supply unit 60 to spray onto the rear surface of the substrate W, thereby increasing the temperature of the substrate W. Alternatively, the substrate heater 40 may be adapted to receive a heated liquid through an extra supplier (not shown) to spray onto the rear surface of the substrate W. The substrate heater 40 may include a plurality of nozzles that spray a relatively high-temperature liquid (greater than 50° C.) onto a plurality of regions on the rear surface of the substrate W so as to minimize the temperature difference between a sprayed region and an unsprayed region of the rear surface of the substrate W. When the substrate heater 40 has the shape of a nozzle as described above, the nozzle may be exposed to the top surface of the rotary chuck 20 so as to continuously spray a relatively high-temperature liquid over the rear surface of the substrate W while the substrate W is held in the rotary chuck 20 and rotated, thereby keeping the temperature of the substrate W relatively constant. In this configuration, the temperature of the cleaning liquid remaining between patterns on the substrate W can be indirectly increased to reduce the surface tension of the cleaning liquid. Furthermore, when the drying liquid is sprayed, the residual cleaning liquid can be replaced with relative ease with the drying liquid. Thus, the residual cleaning liquid can be effectively removed from the substrate W.

The substrate heater 40 may also be formed in the shape of a thermal plate that transfers heat to the substrate W. More specifically, a thermal plate that directly generates heat and the substrate W may be located adjacent or close to each other so that the heat generated by the thermal plate may be transferred to the substrate W to increase the temperature of the substrate W. For instance, the substrate heater 40 may be disposed on a portion of the front surface of the substrate W as well as on the rear surface thereof in such a way as to heat the substrate W.

The substrate heater 40 may also be configured to heat the substrate W by irradiating the substrate W with laser light. More specifically, when a region of the substrate W is irradiated with a relatively high-energy laser light, the energy level of the irradiated region increases so as to cause the temperature of the substrate to also increase. The substrate heater 40 may not be located close to the substrate W but instead be spaced apart at a desired distance from the front or rear surface of the substrate W.

The cleaning liquid supply unit 50 may supply a cleaning liquid such as DI water or medical solutions to the nozzle system 30. For the manufacture of semiconductor devices or semiconductor chips, a substrate (wafer) made of silicon is processed using semiconductor equipment. When the substrate typically undergoes various semiconductor fabrication processes such as lithography, chemical or physical deposition, and plasma etching, foreign materials such as compounds or dust particles or contaminants may remain on the surface of the substrate. In order to improve the quality of semiconductor devices, foreign materials or contaminants remaining on a wafer surface need to be completely removed using a cleaning process such as washing and drying. According to example embodiments, foreign materials or contaminants left on the surface of the substrate W may be cleaned by delivering the cleaning liquid from the cleaning liquid supply unit 50 to the nozzle system 30 and then spraying the cleaning liquid onto the substrate W through the nozzle system 30.

The drying liquid supply unit 60 may supply a drying liquid including isopropyl alcohol (IPA) or a similar material to the nozzle system 30. When DI water is used as the cleaning liquid for the cleaning process, the surface of the substrate W made of silicon tends to dissolve in the DI water. Thus, a wafer has to be completely dried in order to prevent occurrences of water spot after the cleaning process. Furthermore, as described above, to prevent collapse of a relatively fine pattern due to the surface tension of the cleaning liquid, a drying liquid having a lower surface tension is substituted for the cleaning liquid having a higher surface tension. Thus, the cleaning liquid is drained from the substrate W. In particular, since the substrate W is held in the rotary chuck 20 and may be rotated at a relatively constant speed of about 300 rpm, the cleaning liquid may be removed by the centrifugal force so as to move radially with respect to the substrate W and be ejected from the substrate W. As described above, when the temperature of the drying liquid increases, the surface tension of the cleaning liquid decreases further, thereby improving the effect of replacing the cleaning liquid with the drying liquid.

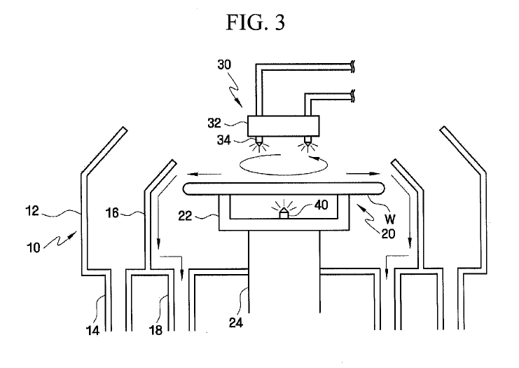

Referring to FIGS. 3 through 5, the housing 10 may further include second barrier walls 16 disposed within the interior space surrounded by the first barrier walls 12 and a second exhaust port 18 disposed within an interior space surrounded by the second barrier walls 16. The second barrier walls 16 may have a different height than that of the first barrier walls 12. The first and second barrier walls 12 and 16 and the first and second exhaust ports 14 and 18 of the housing 10 and the rotary chuck 20 with a vertically adjustable height may constitute a drying liquid recycling system.

As described above, the rotary chuck 20 may have a height that can be adjusted vertically. When a cleaning liquid such as DI water is sprayed onto the substrate W through the nozzle system 30, the rotary chuck 20 may be lowered so that a cleaning liquid containing the contaminants is subjected to a centrifugal force of the substrate W and flows towards the second exhaust port 18 along the second barrier wall 16. Since the cleaning liquid drained out of the second exhaust port 18 contains contaminants, the cleaning liquid is collected for proper disposal. A purification filter (not shown) may be installed to filter out the contaminants so that the resulting cleaning liquid may be transported back to the cleaning liquid supply unit 50 for reuse.

After stopping the supply of the cleaning liquid to the substrate W, a drying liquid is sprayed onto the substrate W in order to completely remove (replace) the supplied cleaning liquid. During an initial process in which the cleaning liquid is sprayed, a mixture of cleaning liquid and drying liquid is pumped out of the second exhaust port 18 along the second barrier walls 16. After the initial amount of the cleaning liquid is removed, a drying liquid such as IPA mostly flows off of the substrate W due to a centrifugal force. The drying liquid (which may be more expensive than the cleaning liquid) can be recycled for reuse without being ejected.

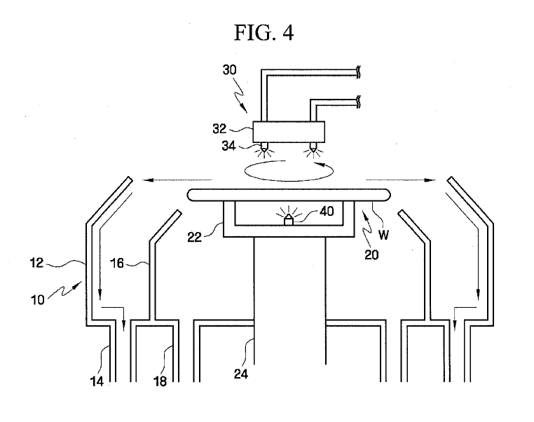

Referring to FIG. 4, when the rotary chuck 20 for supporting the substrate W is raised after removal of the initial amount of cleaning liquid, the drying liquid that flows off the substrate W due to the centrifugal force passes above the second barrier wall 16, is blocked by the first barrier wall 12 which is higher than the second barrier wall 16, and flows toward the first exhaust port 14. Since the housing 10 includes the first and second barrier walls 12 and 16 having different heights, the supplied liquids can be selectively separated for recycling of the more expensive drying liquid. Alternatively, the heights of the first and second barrier walls 12 and 16 may be adjusted while the rotary chuck 20 remains at a fixed height. More specifically, the second barrier wall 16 may be raised in order to drain the cleaning liquid with the contaminants out of the second exhaust port 18. Conversely, the second barrier wall 16 may be lowered to drain the drying liquid out of the first exhaust port 14 for recycling.

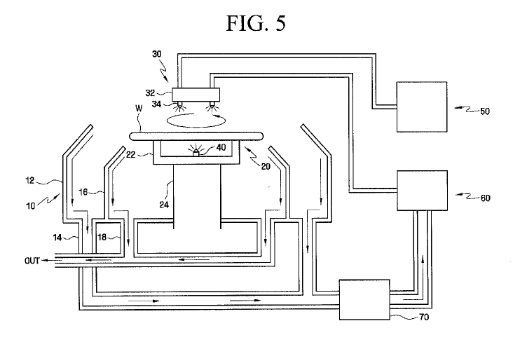

Referring to FIG. 5, a recycling unit 70 may be further disposed in a portion of a pipe connected to the first exhaust port 14 so as to collect a drying liquid drained out of the first exhaust port 14 and transport the drying liquid back to the drying liquid supply unit 60 for reuse. The recycling unit 70 may have therein a filter (not shown) for filtering out the drying liquid and a supply pump (not shown) for transporting the filtered drying liquid back to the drying liquid supply unit 60. The filter may include a zeolite membrane for separating the cleaning liquid and the drying liquid based on molecular weight.

The drying liquid recycling system, which may include the first and second barrier walls 12 and 16 and the first and second exhaust ports 14 and 18 of the housing 10, the rotary chuck 20 with vertically adjustable heights, and the recycling unit 70, allows recycling of the relatively expensive drying liquid that is drained, thereby reducing the manufacturing cost.

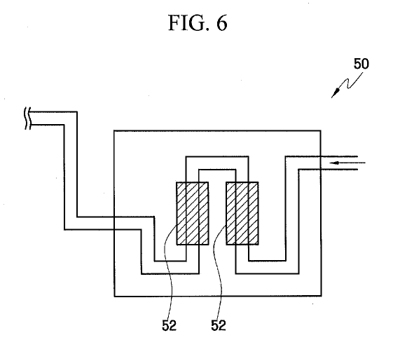

The configuration of the cleaning liquid supply unit 50 and the drying supply unit 60 will now be described with reference to FIGS. 6 through 8

FIG. 6 schematically illustrates the internal configuration of the cleaning liquid supply unit 50. As described above, when the temperature of the cleaning liquid increases, its surface tension decreases, thereby increasing the cleaning and drying effects. The cleaning liquid supply unit 50 may supply the cleaning liquid at a higher temperature (e.g., 50° C. or more) to the nozzle system 30. DI water may be used as the cleaning liquid. Since the DI water can be directly heated, the temperature of the supplied DI water may be increased as it passes through a first fluid heater 52.

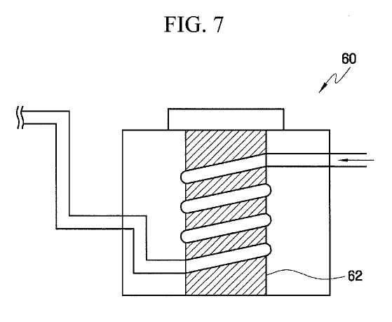

FIG. 7 schematically illustrates the internal configuration of the drying liquid supply unit 60. As described above, when the temperature of the drying liquid increases, its surface tension decreases, thereby increasing the effect of removing or replacing the cleaning liquid. The drying liquid supply unit 60 may supply the drying liquid at a relatively high temperature (e.g., in the range of about 50° C. to about 80° C.) to the nozzle system 30. IPA may be used as the drying liquid. Since the IPA may ignite in the atmosphere when it is heated above 80° C., thus causing safety concerns (unlike DI water), the IPA can be heated indirectly using a water bath so that it is kept at a temperature range between about 50° C. and about 80° C. More specifically, referring to FIG. 7, water may fill the drying liquid supply unit 60, and at least one heating rod 62 may be disposed in the center of the drying liquid supply unit 60 so as to heat the water. A supply tube for the supplied drying liquid may wrap around or pass close to the heating rod 62. Thus, the temperature of the drying liquid may be increased by the water and/or the heating rod 62. As the supply tube for the drying liquid passing through the inside of the drying liquid supply unit 60 becomes longer, the temperature of the drying liquid may increase to a greater extent. Thus, the length of the supply tube may be adjusted depending on the desired temperature range.

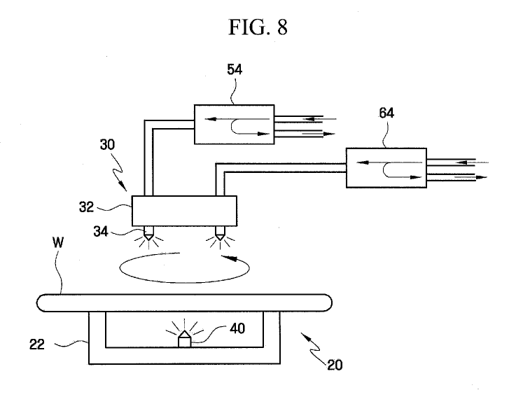

Referring to FIG. 8, when the cleaning liquid or drying liquid heated at the desired temperature range is supplied to the nozzle system 30, the temperature of the cleaning or drying liquid may decrease. Thus, the apparatus for drying the substrate W according to example embodiments of the present invention may further include a first dispenser 54 disposed between the cleaning liquid supply unit 50 and the nozzle system 30 and a second dispenser 64 disposed between the drying liquid supply unit 60 and the nozzle system 30. The first and second dispensers 54 and 64 respectively detect the temperatures of the cleaning liquid and the drying liquid being supplied to the nozzle system 30. If the temperatures do not fall within a desired range, the cleaning liquid and/or the drying liquid may be transported back to the cleaning liquid supply unit 50 and/or the drying liquid supply unit 60. In particular, when the first and second dispensers 54 and 64 are disposed adjacent to the nozzle system 30, the final temperatures of the cleaning liquid and the drying liquid being supplied to the nozzle system 30 may be controlled with relative ease.

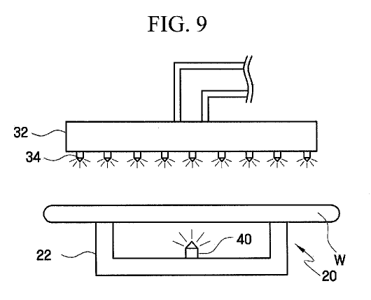

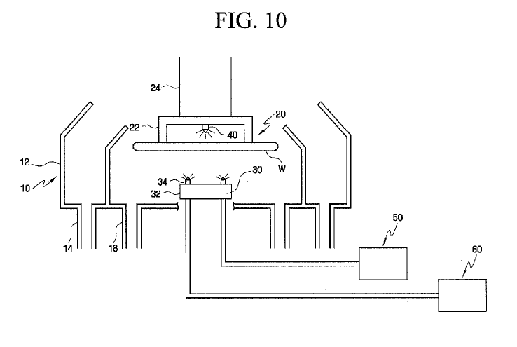

FIG. 9 illustrates a modified example of the nozzle system 30. More specifically, the nozzle system 30 may include bar-type nozzles in order to reduce the surface tension by spraying a heated fluid more uniformly over the substrate W through the nozzle system 30. For instance, when the length of one surface of the nozzle system 30 is equal to a radius or diameter of the substrate W, it is possible to increase the temperature more uniformly across the entire substrate W, particularly when the substrate W is rotating at greater than 300 rpm.

Another apparatus for drying a substrate according to example embodiments of the present invention will now be described with reference to FIG. 10. The apparatus for drying a substrate according to example embodiments may include a housing 10 with first barrier walls 12 having a first height, a rotary chuck 20 disposed within the housing 10 so as to support and rotate a substrate W. The substrate W may be supported with its front surface having a pattern thereon facing downward and a rear surface facing upward. A nozzle system 30 may be disposed below the rotary chuck 20 so as to supply a fluid onto the substrate W. A cleaning liquid supply unit 50 may supply a cleaning liquid for cleaning the substrate W to the nozzle system 30, and a drying liquid supply unit 60 may supply a drying liquid for drying the substrate W to the nozzle system 30.

As shown in FIG. 10, the apparatus is configured such that the front surface of the substrate W faces downward while the rear surface faces upward. Thus, the nozzle system 30 for cleaning and drying the front surface of the substrate W is disposed below the substrate W. The rest of the structure is substantially the same as that of the apparatus of FIG. 1.

When the substrate W is fixed upside down as shown in FIG. 10, the cleaning liquid may be prevented from being introduced onto the front surface of the substrate W. More specifically, if the substrate W is fixed at a normal position (e.g., FIG. 1), the drying liquid is sprayed onto the front surface of the substrate W after the cleaning process. As described above, in order to maximize the effect of removing or replacing the cleaning liquid with the drying liquid, the temperature of the residual cleaning liquid remaining on the substrate W should be increased so as to reduce the surface tension by increasing the temperature of the substrate W. In this case, when a substrate heater 40 heats the substrate W by spraying relatively high-temperature DI water onto the rear surface of the substrate W, the DI water flows toward edges of the rotating substrate W due to a centrifugal force. However, some DI water may flow back from the perimeter of the substrate W to the front surface thereof. In order to prevent this phenomenon, a process of blocking the backflow of the cleaning liquid to the front surface may be performed by spraying the drying liquid onto the front surface of the substrate W after spraying the cleaning liquid onto the rear surface thereof. More specifically, after the spraying of the cleaning liquid onto the rear surface of the substrate W has stopped, a drying liquid is sprayed onto the front surface of the substrate W for a desired period so that drying liquid particles moving radially due to the centrifugal force push away the cleaning liquid flowing back from the rear surface to the front surface, thereby blocking the backflow of the cleaning liquid. Thus, since the amount of time the relatively high-temperature cleaning liquid is sprayed onto the rear surface of the substrate W is reduced, the temperature of the substrate W may increase. In particular, during the process of spraying the drying liquid onto the front surface of the substrate W in order to block the backflow of the cleaning liquid, the temperature of the substrate W may decrease such that the surface tension is increased.

To avoid this, in the apparatus for drying a substrate according to example embodiments, the substrate W may be fixed upside down as shown in FIG. 10. More specifically, when the front surface of the substrate W with a pattern thereon faces downward and the rear surface thereof faces upward, it is possible to block the backflow of cleaning liquid along the perimeter of the substrate W. Thus, without the need to cease the process of spraying a relatively high-temperature cleaning liquid, the cleaning liquid can be sprayed onto the rear surface of the substrate W until completing the spraying of the drying liquid onto the front surface thereof. Unlike in the apparatus of FIG. 1, a decrease in the temperature of the substrate W can be prevented.

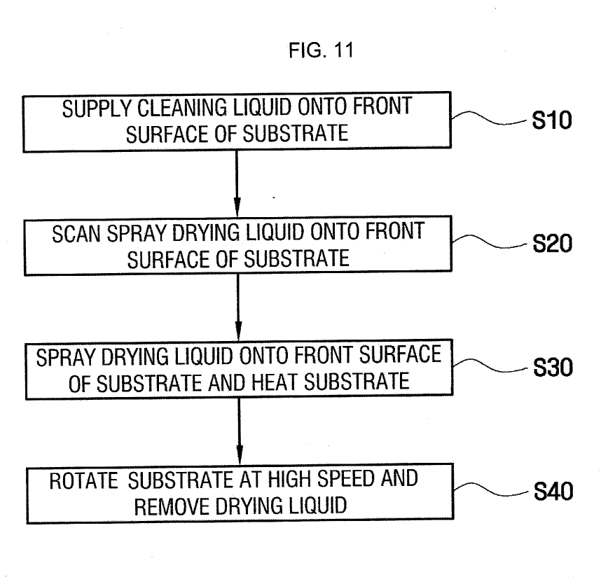

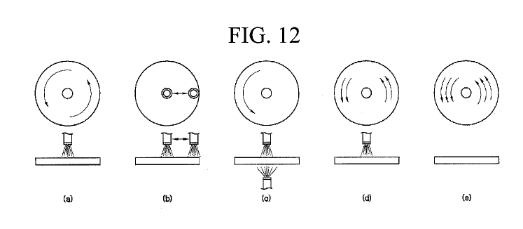

A method of drying a substrate according to example embodiments of the present invention will now be described with reference to FIGS. 11 and 12.

The method of drying a substrate according to example embodiments may include supplying a cleaning liquid onto a front surface of a rotating substrate with a pattern thereon (S10), moving between a center of the front surface and an edge thereof and spraying a drying liquid onto the front surface thereof (S20), heating the substrate while spraying the drying liquid onto the front surface thereof (S30), and rotating the substrate at a relatively high speed and removing the drying liquid (S40).

As described above, after performing various semiconductor fabrication processes, foreign materials (e.g., compounds or dust particles or contaminants) may remain on the surface of the substrate. A cleaning liquid (e.g., DI water) may be sprayed onto a front surface of the substrate that rotates at 300 rpm to 1000 rpm in order to clean the front surface of the substrate (S10). During removal of the contaminants, the DI water may be kept at room temperature or a higher-temperature cleaning liquid (e.g., heated above 50° C. by the first fluid heater 52) may be sprayed as described above.

After the contaminants are removed, in order to remove the cleaning liquid and dry the substrate, the cleaning liquid ceases to be supplied onto the surface of the substrate, and a drying liquid (e.g., IPA) is sprayed thereon (S20). As described above, to more efficiently remove a residual cleaning liquid from the substrate by reducing the surface tension, the drying liquid may be heated between about 50° C. and 80° C. In an initial operation of spraying the drying liquid, the drying liquid may be applied relatively uniformly across the entire substrate. Thus, in order to prevent damage to or unevenness of the substrate surface due to contaminants remaining on the substrate surface, as shown in FIG. 12B, the drying liquid may be sprayed while reciprocating between the center and edge of the substrate several times (e.g., two to three times).

The substrate may be heated while at the same time spraying the drying liquid onto the front surface of the substrate (S30). When the substrate is heated, the temperature of the cleaning liquid remaining on the pattern of the substrate is increased so the surface tension of the cleaning liquid is reduced. Thus, the residual cleaning liquid can be removed with greater ease from the substrate. In order to heat the substrate, a relatively high-temperature cleaning liquid or drying liquid may be sprayed onto the rear surface of the substrate, the substrate W may be irradiated with laser light, and/or heat may be transferred to the substrate through a thermal plate. It should be understood that at least one of these methods may be used to heat the substrate.

When a relatively high-temperature cleaning liquid is sprayed onto the rear surface of the substrate to heat the substrate, the substrate drying method according to example embodiments of the present invention may further include spraying the drying liquid only onto the front surface of the substrate when the cleaning liquid ceases to be supplied onto the rear surface thereof. As described above, when the relatively high-temperature cleaning liquid is supplied onto the rear surface of the substrate to increase the temperature of the substrate, some of the cleaning liquid may flow back to the front surface along the perimeter of the substrate. To prevent the backflow of the cleaning liquid, the cleaning liquid may crease to be supplied onto the rear surface thereof, while the drying liquid may be sprayed onto the front surface of the substrate W for a desired period so as to push away the cleaning liquid flowing back from the rear surface out of the substrate. Such an operation may be performed repeatedly until the cleaning liquid supplied to the rear surface is completely removed.

Since the drying liquid has a relatively low surface tension and the heated drying liquid is applied to the substrate, the drying liquid can be removed from the substrate with relative ease during the drying process.

The drying liquid may cease to be supplied, and the substrate may be rotated at a relatively high speed so as to remove the drying liquid (S40). More specifically, after the spray of the drying liquid for removal of the cleaning liquid is stopped, a residual drying liquid may be removed by increasing the rotation speed up to a range of 500 rpm to 2,000 rpm. Since the drying liquid has a relatively low surface tension and the heated drying liquid is applied to the substrate, the drying liquid can be removed from the substrate with relative ease, thereby facilitating the drying operation.

While the present invention has been particularly shown and described with reference to example embodiments thereof, it will be understood by those of ordinary skill in the art that various changes in form and details may be made therein without departing from the spirit and scope of the present invention as defined by the following claims. It is therefore desired that example embodiments be considered in all respects as illustrative and not restrictive, with reference being made to the appended claims rather than the foregoing description to indicate the scope of the invention.

What is claimed is:

1. An apparatus for drying a substrate, the apparatus comprising:
a housing including a first barrier wall having a first height;
a rotary chuck disposed within the housing and configured to rotate the substrate;
a nozzle system disposed above or below the rotary chuck and configured to supply a fluid onto the substrate;
a cleaning liquid supply unit configured to supply a cleaning liquid for cleaning the substrate to the nozzle system; and
a drying liquid supply unit configured to supply a drying liquid for drying the substrate to the nozzle system.

2. The apparatus of claim 1, wherein the cleaning liquid is deionized (DI) water.

3. The apparatus of claim 1, wherein a temperature of the cleaning liquid is above 50° C.

4. The apparatus of claim 1, wherein the cleaning liquid supply unit includes a first fluid heater configured to heat the cleaning liquid.

5. The apparatus of claim 4, wherein the cleaning liquid supply unit further includes a first dispenser disposed adjacent to the nozzle system, the first dispenser configured to detect a temperature of the cleaning liquid and configured to transport the cleaning liquid back to the first fluid heater if the temperature is below 50° C.

6. The apparatus of claim 1, wherein the drying liquid is isopropyl alcohol (IPA).

7. The apparatus of claim 1, wherein a temperature of the drying liquid ranges from 50° C. to 80° C.

8. The apparatus of claim 1, wherein the drying liquid supply unit further includes a second fluid heater configured to heat the drying liquid.

9. The apparatus of claim 8, wherein the second fluid heater is configured to indirectly heat the drying liquid using higher temperature water.

10. The apparatus of claim 8, wherein the drying liquid supply unit further includes a second dispenser disposed adjacent to the nozzle system, the second dispenser configured to detect a temperature of the drying liquid and configured to transport the drying liquid back to the second fluid heater if the temperature is below 50° C.

11. The apparatus of claim 1, wherein the housing further includes a second barrier wall and a first exhaust port, the second barrier wall disposed within an interior space surrounded by the first barrier wall, the second barrier wall having a different height than that of the first barrier wall, and the first exhaust port disposed in a bottom surface of the housing between the first and second barrier walls.

12. The apparatus of claim 11, wherein the first barrier wall is higher than the second barrier wall.

13. The apparatus of claim 11, wherein the height of at least one of the rotary chuck, the first barrier wall, and the second barrier wall is adjustable.

14. The apparatus of claim 11, further comprising:
a recycling unit connected to the first exhaust port and configured to collect and recycle a drying liquid drained out of the first exhaust port.

15. The apparatus of claim 14, wherein the recycling unit includes a filter configured to filter out the drying liquid, the filter including a zeolite membrane.

16. The apparatus of claim 11, wherein the housing further includes a second exhaust port disposed in a bottom surface of the housing within the interior space surrounded by the second barrier wall.

17. The apparatus of claim 16, wherein the second exhaust port is configured to draw out the cleaning liquid and contaminants expelled from the substrate.

18. The apparatus of claim 1, further comprising:
a substrate heater configured to heat the substrate, the substrate heater configured to spray a higher-temperature cleaning liquid or higher-temperature drying liquid onto a rear surface of the substrate.

19. The apparatus of claim 18, wherein the substrate heater is configured to spray the higher-temperature cleaning liquid or higher-temperature drying liquid while moving between a center and an edge of the rear surface of the substrate.

20. The apparatus of claim 18, wherein the substrate heater is a thermal plate configured to transfer heat to the substrate, or the substrate heater is configured to heat the substrate by irradiating the substrate with laser light.

21. An apparatus for drying a substrate, the apparatus comprising:
a rotary chuck disposed within a housing structure, the rotary chuck configured to rotate a substrate;
a nozzle system configured to dispense a cleaning liquid from a cleaning liquid supply unit and a drying liquid from a drying liquid supply unit onto the substrate, the drying liquid having a lower surface tension than the cleaning liquid; and
a heating system disposed upstream from the nozzle system, the heating system configured to heat at least one the cleaning liquid and the drying liquid.

22. The apparatus of claim 21, wherein the heating system includes a heater configured to directly heat the cleaning liquid.

23. The apparatus of claim 21, wherein the heating system includes a liquid bath configured to indirectly heat the drying liquid.

24. The apparatus of claim 21, further comprising:
a recycling unit connected to the housing structure through an exhaust port, the recycling unit configured to recover the drying liquid dispensed by the nozzle system and to return the recovered drying liquid to the drying liquid supply unit.

25. A method of drying a substrate, the method comprising:
supplying a heated drying solution onto a front surface of the substrate to displace a cleaning solution on the front surface while rotating the substrate at a first speed, the drying solution having a surface tension that is lower than a surface tension of the cleaning solution;
increasing a temperature of the substrate by heating a rear surface of the substrate to reduce the surface tension of the cleaning solution so as to facilitate the displacement of the cleaning solution by the drying solution, the rear surface being opposite to the front surface; and
expelling the drying solution from the substrate while rotating the substrate at a second speed, the second speed being greater than the first speed.

26. The method of claim 25, wherein the drying solution is heated with a higher-temperature heating liquid without mixing the drying solution and the higher-temperature heating liquid.

27. The method of claim 25, wherein the drying solution is supplied at a temperature ranging from 50 to 80° C.

28. The method of claim 25, wherein the drying solution is isopropyl alcohol and the cleaning solution is deionized water.
